(19) United States
(12) Patent Application Publication
(10) Pub. No.: US 2012/0123745 A1
(43) Pub. Date: May 17, 2012

(54) Adaptive Content-aware Aging Simulations

(75) Inventors: Bing Jay Sheu, Hsin-Chu (TW); Chien-Hua Huang, Zhubei City (TW); David Barry Scott, Plano, TX (US)

(73) Assignee: Taiwan Semiconductor Manufacturing Company, Ltd., Hsin-Chu (TW)

(21) Appl. No.: 12/947,016

(22) Filed: Nov. 16, 2010

(51) Int. Cl. G06F 17/10; G06F 17/50

(52) U.S. Cl. 703/2

(57) ABSTRACT

A system and method for simulating aging parameters of a System-on-Chip (SoC) integrated circuit is disclosed. A SoC integrated circuit is first divided into a plurality of blocks in accordance with the nature or the operating conditions of each block. The simulation of a digital circuit based block is performed by a static timing analyzer. The simulation of a mixed signal based block is performed by first employing a fresh device model to obtain relevant operation conditions, such as node voltages. Based upon the operation conditions and reliability characterization data, parameters degradation calculators assess aging characteristic factors of each block. In a subsequent simulation, a circuit simulator calculates the design corners of a SoC chip based upon the characteristic factors of each block.

### BACKGROUND

System-on-chip (SoC) technology is integrating multiple functional blocks on a single silicon chip. The multiple functional blocks may include digital circuits, analog circuits, mixed-signal circuits or any combination thereof. This technology reduces development cycle and manufacture costs while increases product reliability, functionality and performance.

On the other hand, a SoC chip is relatively complicated. Such a complicated chip having various types of functional blocks demands a thorough reliability analysis before going through an expensive and time-consuming fabrication process. Semiconductor aging has emerged as a major factor for an SoC chip's reliability. Aging induced defects include Hot Carrier Injection (HCI), which relates to the change of electrons/holes' mobility; Electron-Migration (EM), which relates to the gradual displacement of the ions in a conductor as a result of the current flowing through the conductor; Negative Bias Temperature Instability (NBTI), which relates to a shift of a threshold voltage of a transistor; and Time Dependent Dielectric Breakdown (TDDB), which refers to the damage accumulated in the gate oxide region of a transistor. In short, HCI, EM, NBTI and TDDB are four major mechanisms of device degradation due to aging effects.

As semiconductor devices advance to submicron sizes, integrated circuit design margins have become so small. Therefore, a proper estimate of aging induced defects will help designers optimize design margins so as to achieve a balance between reliability and cost. Simulation tools such as Simulation Program with Integrated Circuits Emphasis (SPICE) can be used to simulate aging induced defects. However, it is not widely known how degradation mechanisms propagate in a SoC chip as a function of a variety of operating conditions. Thus, an adaptive content-aware aging simulation method is needed to predict semiconductor degradation.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates the concept of an optimized estimate of electrical parameters degradation due to device aging;

FIG. 2 illustrates a hybrid simulation method for assessing electrical parameters degradation in a system-on-chip (SoC) integrated circuit in accordance with an embodiment;

FIG. 3 illustrates a work flow of an aging characteristic factor simulation process based upon an adaptive content-aware aging simulation method;

FIG. 4 illustrates an example using the adaptive content-aware aging simulation method in accordance with an embodiment; and

FIG. 5 illustrates a simplified block diagram of a computer system that can be used to implement the aging simulation method in accordance with an embodiment.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely an adaptive content-aware aging simulation method for a system-on-chip (SoC) integrated circuit. The invention may also be applied, however, to a variety of integrated circuits.

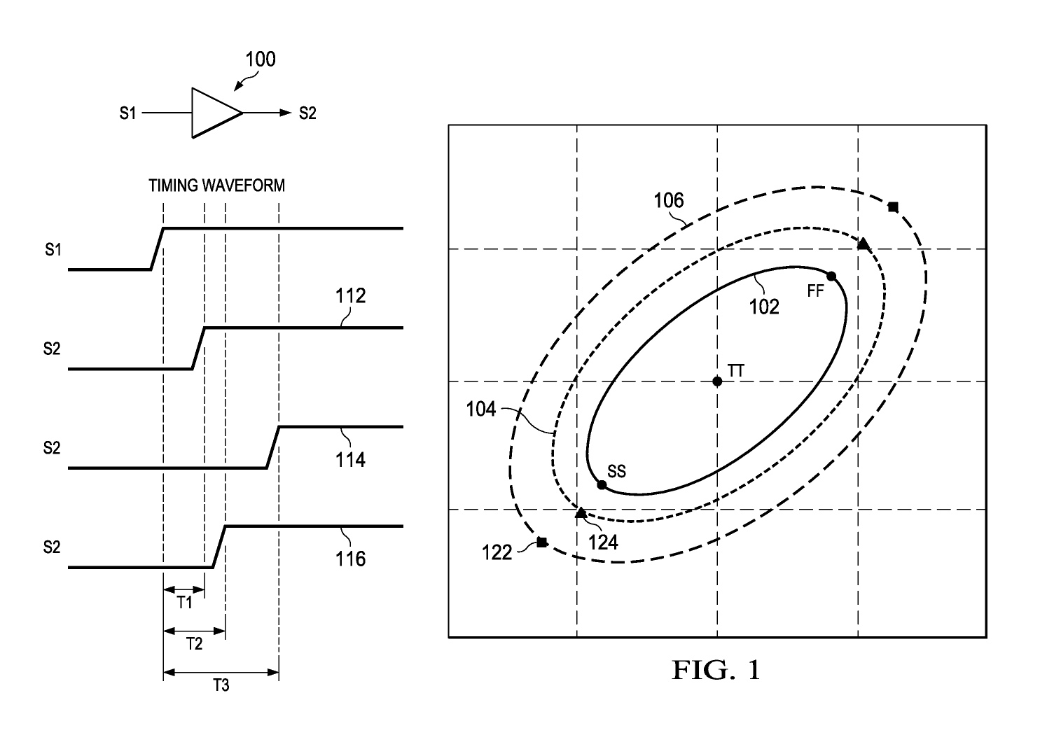

Referring initially to FIG. 1, the concept of an optimized estimate of electrical parameters degradation due to device aging is illustrated. A semiconductor device 100 has an input signal S1 and an output signal S2. The semiconductor device 100 may be a buffer, an inverter, a logic gate or any combination thereof. In accordance with an embodiment, a buffer is used to illustrate an embodiment. When the input signal S1 is applied to the semiconductor device 100, a curve 112 represents a timing waveform of the output signal S2 when the semiconductor device 100 is a fresh device. As shown in FIG. 1, T1 is the propagation delay between the input signal S1 and the output signal S2.

The propagation delay in a buffer (e.g., semiconductor device 100) may increase due to device aging. In view of aging effects, a curve 114 represents the output signal S2 based upon an End-of-Life (EOL) model, which is a conservative method for assessing electrical parameters degradation because the worst case values are used as inputs for estimating design corners for electrical parameters. T3 is the delay time between the input signal S1 and the output signal S2 under the EOL model. As described above, the EOL model may result in a pessimistic estimate because it may not consider operating conditions and stress variations. In contrast, a curve 116 represents the output signal S2 based upon an adaptive content-aware aging model, in which some operating conditions such as Process, Voltage and Temperature (PVT) variations and operating cycles are included, so that an optimized propagation delay can be achieved. As shown in FIG. 1, T2 is the delay between the input signal S1 and the output signal S2 based upon the adaptive content-aware aging model. One advantageous feature of using the adaptive content-aware aging model is that the amount of delay time in a digital gate can be reduced so as to gain a competitive edge.

It should be noted that the delay time between an input signal and an output signal used in the previous example are selected purely for demonstration purposes and are not intended to limit the various embodiments to any particular electrical parameters. One of ordinary of skill in the art will realize that the proposed adaptive content-aware aging simulation method can be applied to other electrical parameters, such as threshold voltage (Vth).

As shown in FIG. 1, an electrical parameter (e.g., Vth) of a group of fresh devices may not stay at a single point due to semiconductor fabrication process variations. Instead, the distribution of the values of this parameter from a group of fresh devices may form a first oval 102. In the semiconductor manufacturing industry, design corners may be named by using two-letter designators. For example, in the first oval 102, the first letter of TT refers to a NMOS design corner, and the second letter of TT refers to a PMOS design corner. TT refers to the typical electrical parameters of a fresh semiconductor chip including both NMOS and PMOS devices.

Due to the variations of semiconductor fabrication processes, such as the temperature changes, some semiconductor chips may have electrical parameters located in the bottom left corner of the first oval 102, which is designated as SS. SS refers to both NMOS and PMOS devices in a semiconductor chip exhibit slow carrier mobility. On the other hand, some semiconductor chips may have electrical parameters located in the upper right corner of the first oval 102, which is designated as FF. FF refers to both NMOS and PMOS devices in semiconductor chip exhibit fast carrier mobility. The rest points in the first oval 102 define the possible combinations a fresh semiconductor chip may have. The first oval 102 provides an illustrative range for a semiconductor designer to design a reliable chip having enough margins to compensate the possible electrical parameter variations.

Semiconductor aging may cause additional electrical parameter shifts. In consideration of semiconductor aging effects, the distribution of the electrical parameters may fall into a larger oval region designated as 106 if a conservative EOL model is used to estimate the variations of the electrical parameters. A square 122 refers to the slowest carrier mobility of a semiconductor chip in consideration of aging effects. The square 122 may correspond to the propagation delay T3 if the semiconductor device 100 is used to illustrate the variation of an electrical parameter under the EOL model.

One embodiment of this invention proposes an optimized estimate of design corners due to aging effects. A third oval 104 defines a region located between the first oval 102 and the second oval 106. In consideration of operating conditions, the proposed method may minimize the scope of electrical parameters variations. A star 124 refers to the slowest carrier mobility of a semiconductor chip under this new aging simulation method. The star 124 may correspond to the propagation delay T2 if the semiconductor device 100 is used to illustrate the variation of the delay time under this optimized method. One advantageous feature of this new method is that by employing this optimized aging simulation method a semiconductor designer can cut unnecessary margins for compensating electrical parameters degradation due to aging effects.

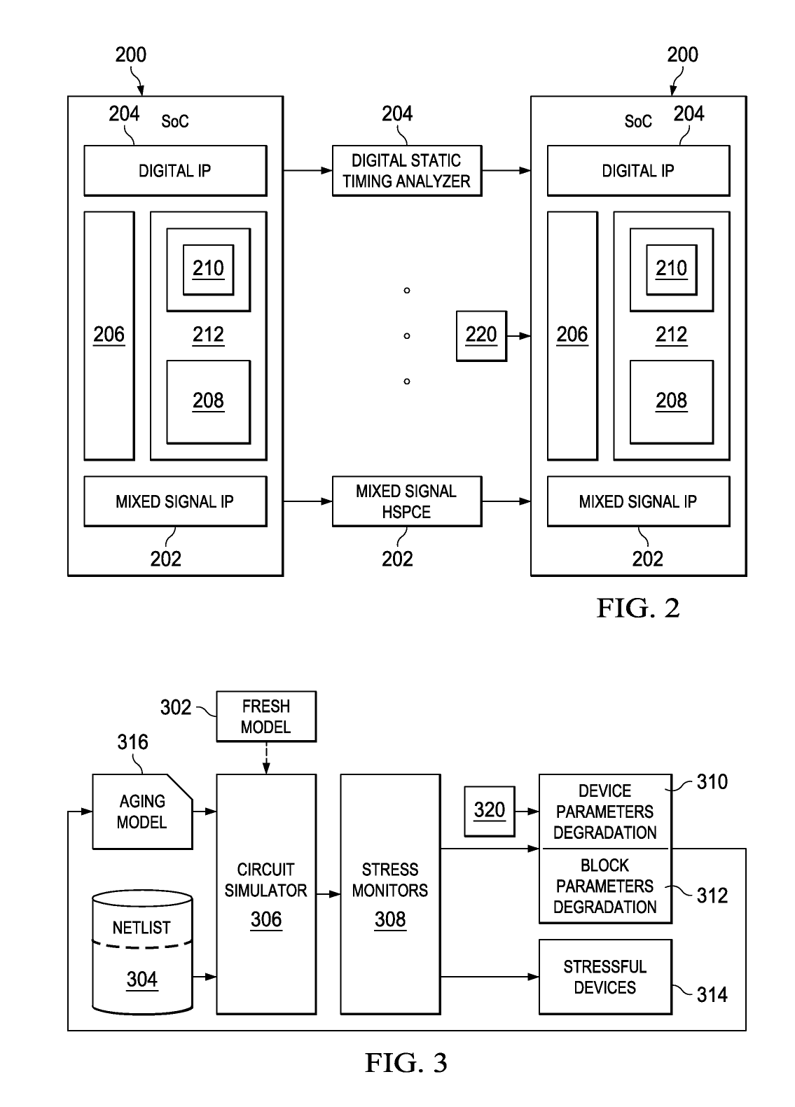

FIG. 2 illustrates a hybrid simulation method for assessing electrical parameters degradation in a SoC chip in accordance with an embodiment. In order to reduce the time-to-market, a SoC chip may integrate a plurality of semiconductor blocks as well as semiconductor Intellectual Property (IP) cores. An IP core is a reusable unit, which can be integrated into a SoC chip. In accordance with an embodiment, an estimate of a SoC chip's design corners can be done by first partitioning the chip along IP boundary, and then dividing an IP core into a plurality of blocks with respect to the nature of each block (digital, analog or mixed signal) or dividing an IP core into a plurality of blocks based upon different operating conditions and stress variations.

It should be noted that if necessary, each block can be further divided into a plurality of sub-blocks and a sub-block can be divided into a plurality of semiconductor devices. A person skilled in the art will recognize that the basic element of this SoC chip for this simulation purpose can be as big as an IP core or as small as a semiconductor device, such as a NMOS switch or a PMOS switch.

In accordance with another embodiment, after a SoC chip has been divided into a plurality of basic elements in view of their operating conditions and reliability requirements. If a basic element such as an IP core is susceptible to semiconductor aging induced defects. The IP core is single out and the adaptive content-aware aging simulation method is applied to assessing the parameter degradation of the IP core. In contrast, if a basic element such as a semiconductor block is not susceptible to semiconductor aging induced defects. A conventional EOL model can be applied to assessing the parameter degradation of the semiconductor block. By partitioning a SoC chip into a plurality of basic elements, the optimized simulation method enables a combination of several different aging models so that a basic element of the SoC chip can be better estimated in consideration its operating conditions and reliability requirements.

As shown in FIG. 2, a SoC chip 200 includes an IP core 204 formed by digital circuits, an IP core 202 formed by mix-signal circuits, a semiconductor block 206 and a semiconductor block 212. Both semiconductor blocks 206 and 212 may include digital, analog, mixed signal circuits or any combination thereof. The semiconductor block 212 further includes a sub-block 208 and a device 210. In consideration of operation conditions and the nature of each element of this SoC chip, the adaptive content-aware simulation method can be applied to any element of this SoC chip. In this example, a basic element for an adaptive content-aware simulation can be an IP core (e.g., IP core 202) as well as a device (e.g., device 210).

In accordance with an embodiment, the aging parameter assessment processes of two IP cores 204 and 202 are used to illustrate the adaptive content-aware simulation method. The IP core 202 includes mixed signal circuits. In order to calculate the aging parameters of the IP core 202, circuit simulators such as Simulation Program with Integrated Circuit Emphasis (SPICE) or its commercial versions such as HSPICE, PSPICE or the like can be used to simulate aging parameters. As described in further detail with respect to FIG. 3, the aging characteristic factor of the IP core 202 can be calculated based upon the operating conditions and stress variations of this IP core. The IP core 204 is formed by a plurality of digital circuits such as ten million logic gates. In a digital circuit based IP core, aging induced delay is a major reliability concern. Instead of simulating the IP core with SPICE or HSPICE, a Static Timing Analyzer (STA) is used to assess aging induced delay. In the SoC chip 200, other elements such as the semiconductor block 206 may be formed by mixed signal circuits. Likewise, a circuit simulator such as HSPICE, PSPICE or the like may be used to simulate the circuits and calculate the aging characteristic factors.

As a hybrid simulation method, the calculated results may be further calibrated by comparing calculated results with a reliability characterization report 220. Based upon the ratio of the amount stress from the simulation and the reference stress index from the reliability characterization report 220, the characteristic factors of each basic element can be determined. In the next step, a SoC chip design corners due to aging effects can be assessed by running a fast circuit simulator such as Heterogeneous Simulation Interoperability Mechanism (HSIM) with aging characteristic factors from each element's simulation results. By employing this method, an advantageous feature is that the adaptive content-aware aging simulation method provides an accurate estimate of a SoC chip's design corners as well as a fast and easy-to-implement simulation.

FIG. 3 illustrates a work flow of an aging characteristic factor simulation process based upon the adaptive content-aware aging simulation method. A fresh device model library 302, an aging device model library 316 and a netlist library 304 are coupled to a circuit simulator 306. A plurality of stress monitors collectively called 308 receive the output from the circuit simulator 306 and generate three types of data sent to a device parameters degradation calculator 310, a block parameters degradation calculator 312 and a stressful device indicator 314.

In an initial simulation step, fresh device models downloaded from the fresh device model library 302 and a netlist from the netlist library 304 are fed into the circuit simulator 306 (e.g., HSPICE). The circuit simulator 306 calculates voltages and currents at all relevant nodes of the netlist. The stress monitors 308 include a plurality of stress calculators for assessing aging induced degradation from different aging effects such as Hot Carrier Injection (HCI), Electro-Migration (EM), Negative Bias Temperature Instability (NBTI), Time Dependent Dielectric Breakdown (TDDB), and the like. In accordance with the calculated stress results, in an embodiment, a device parameters degradation calculator 310 loads the calculated stress and compares with a reference stress report 320 from device characterization data. Based upon the ratio of the calculated stress versus the reference stress in the reference stress report 320, the device's aging characteristic factors are determined. The new device aging characteristic factors reflect its operating conditions and the corresponding aging effects. Likewise, a semiconductor block including a plurality of devices having similar operating conditions is sent into a block parameters degradation calculator 312 wherein the characteristic factors of this block are modified to reflect its operating conditions.

It should be noted that FIG. 3 illustrates only two parameters degradation blocks of a SoC chip that may include a plurality of parameters degradation blocks in accordance with the partition of a SoC chip. The number of parameter degradation model constructing blocks illustrated herein is limited solely for the purpose of clearly illustrating the inventive aspects of the various embodiments. The present invention is not limited to any specific number of parameter degradation model constructing blocks.

The stress monitors 308 are capable of identifying stressful devices based upon the amount of stress calculated from the simulation results. If the amount of stress of a device is over the max value to which the device is specified, the stress monitor 308 reports the stressful devices to a stressful device indicator 314. The stressful device warning can help designers better estimate the aging effects so as to design a reliable device.

The outputs from parameters degradation calculators 310 and 312 may be looped back to the aging model library 316. All device parameters will be updated according to the device degradation values. If necessary, subsequent circuit simulations will be launched using updated device parameters. Based upon more accurate device parameters, parameters degradation calculators 310 and 312 may repeat the process of determining aging characteristic factors described above. Therefore, more accurate aging characteristic factors may be obtained.

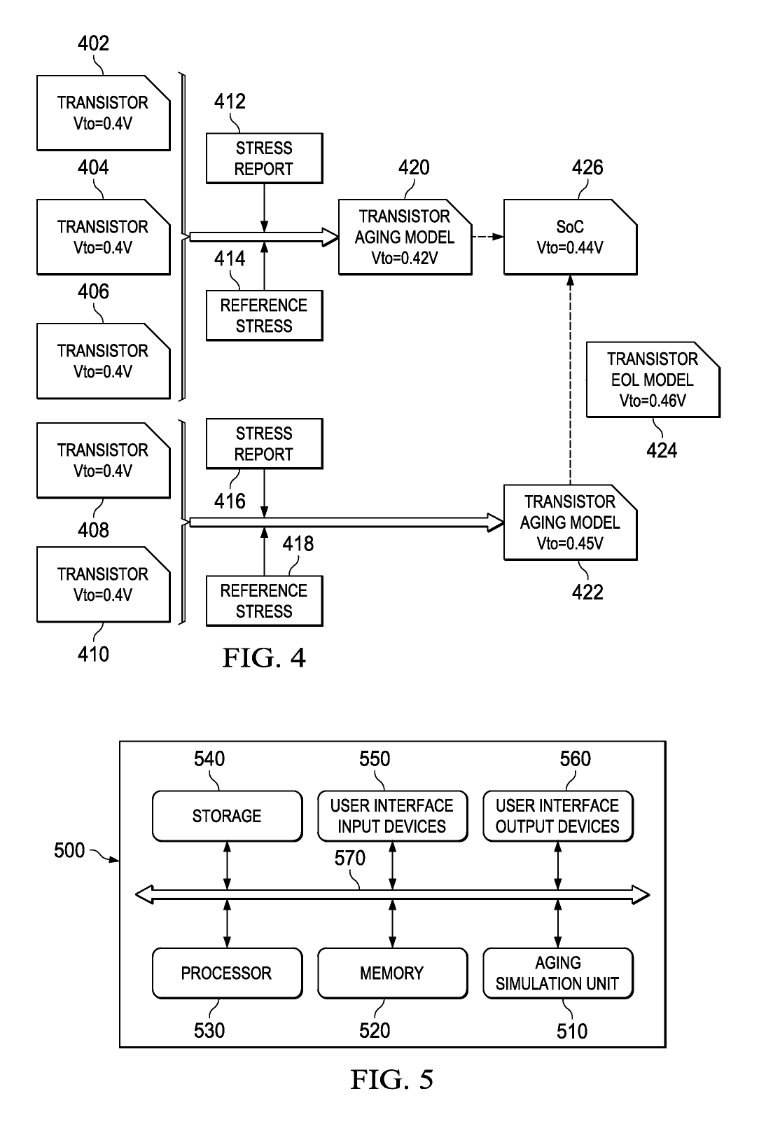

FIG. 4 illustrates an example using the adaptive content-aware aging simulation method in accordance with an embodiment. A SoC chip may include a first transistor 402, a second transistor 404, a third transistor 406, a fourth transistor 408 and a fifth transistor 410. It should be recognized that while FIG. 4 may illustrate the SoC chip having five transistors, the SoC chip may accommodate any number of transistors or other semiconductor devices and still remain within the scope of the present invention.

In accordance with a fresh device model, five transistors have the same threshold voltage (e.g., Vto=0.4V). If an EOL model is applied to these five transistors, five transistor will have the same aging threshold voltage (e.g., Vto=0.46V) as shown in a transistor EOL model 424. As described above with respect to FIG. 3, the shifts of the threshold voltage may be better estimated by taking operating conditions and reliability characterization data into consideration. In accordance with an embodiment, from the simulation results based upon the method described in FIG. 3, a stress report 412 from a simulation tool such as HSPICE shows that transistors 402, 404 and 406 share the similar operating condition. Then, the parameters degradation block (not shown but illustrated in FIG. 3) is adapted to receive reliability characterization data from a reference stress report 414. The reference stress report 414 is based on actual chip information instead of estimated data. Furthermore, the parameters degradation block derives an aging threshold voltage based upon the ratio of calculated stress versus the reference stress from the reference stress report 414. Subsequently, the aging threshold voltage of these three transistors is sent to an aging parameter library 420. The aging parameters (e.g., Vto=0.42V) in the aging parameter library 420 will be updated accordingly.

Likewise, a stress report 416 shows that the transistors 408 and 410 share the similar operating condition. Based upon their operating condition and the corresponding reliability characterization data from a reference stress report 418, the parameters degradation block (not shown but illustrated in FIG. 3) derives an aging threshold voltage. The aging parameters (e.g., Vto=0.45V) will be updated accordingly in an aging parameter library 422. After five transistors' aging parameters have been calibrated through a first simulation based upon fresh device models, the SoC chip's aging parameter can be determined by running a SoC level simulation using a simulation tool such as HSIM. It should be noted that before running a SoC level simulation, the parameters degradation blocks may update each transistor's library model and repeat the simulation again based upon the updated library models. More accurate aging models may be derived from the method discussed above. In this example, using aging parameters from library 422 and library 420, a fast SoC level simulation shows the SoC level threshold voltage degradation (e.g., Vto=0.44V).

FIG. 5 illustrates a simplified block diagram of a computer system 500 that can be used to implement the aging simulation method in accordance with an embodiment. The computer system 500 includes an aging simulation unit 510, a memory 520, a processor 530, a storage unit 540, user interface input devices 550, user interface output devices 560 and a data bus 570. It should be noted that this diagram is merely an example of a personal computer, which should not unduly limit the scope of the claims. Many other configurations of a personal computer are within the scope of this disclosure. One of ordinary skill in the art would also recognize the aging simulation method may be performed by other computer systems including a portable computer, a workstation, a network computer, or the like.

The aging simulation unit 510 may be a physical device, a software program, or a combination of software and hardware such as Application Specific Integrated Circuits (ASIC). In accordance with an embodiment, when a user launches the aging simulation method through the user interface input devices 550, the processor 530 loads the circuit block information and other relevant data from the storage unit 540. According to an embodiment, the aging simulation method is implemented as a software program, the process 530 loads the software program from the aging simulation unit 510 and operates it in the memory 520. After the processor 530 performs each step of FIGS. 3, the processor 530 sends the aging simulation results to the user interface output devices 560. In accordance with the simulation results, design corners can be estimated.

Although embodiments of the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
simulating a circuit block using a simulation tool and deriving a first set of electrical parameters;
calculating a first set of stress indexes based upon the first set of electrical parameters;
receiving a semiconductor characterization report having a set of reference stress indexes and corresponding aging characteristic factors; and
determining a first set of aging characteristic factors based upon a ratio of the first set of stress indexes versus the set of reference stress indexes.

2. The method of claim 1 further comprising:
providing a set of fresh device models;
providing a netlist of the circuit block; and
modifying the set of fresh device models and obtaining a set of aging device models based upon the aging characteristic factor.

3. The method of claim 2 further comprising:
simulating the circuit block based upon the set of aging device models and deriving a second set of electrical parameters;
calculating a second set of stress indexes based upon the second set of electrical parameters; and
determining a second set of aging characteristic factors based upon a ratio of the second set of stress indexes versus the set of reference stress indexes.

4. The method of claim 1, wherein the circuit block is a semiconductor element selected from the group consisting of an intellectual property core, a semiconductor block, a semiconductor sub-block, and a semiconductor device

5. The method of claim 1 further comprising:
identifying the circuit block having an inadequate stress margin.

6. The method of claim 1, wherein the simulation tool is one of a Simulation Program with Integrated Circuits Emphasis (SPICE), HSPICE and PSPICE circuit simulation.

7. The method of claim 1, wherein the first set of electrical parameters comprises at least one of a voltage at a node of the circuit block, a current flowing through a path of the circuit block and a temperature at an area of the circuit block.

8. The method of claim 1, wherein the simulation tool is a static timing analyzer.

9. A method comprising:
partitioning a circuit into a plurality of circuit blocks;
simulating each circuit block of the plurality of circuit blocks using a first simulation tool and deriving a first set of electrical parameters for each circuit block;
calculating a first set of stress indexes based upon the first set of electrical parameters;
receiving a semiconductor characterization report having a set of reference stress indexes and corresponding aging characteristic factors;
determining a first set of aging characteristic factors based upon a ratio of the first set of stress indexes versus the set of reference stress indexes.
simulating the circuit using a second simulation tool using the first set of aging characteristic factors of each circuit block; and
determining a set of design corners of the circuit.

10. The method of claim 9 further comprising:
providing a set of fresh device models;
providing a netlist of each circuit block; and
modifying the fresh device models and obtaining a set of aging device models based upon the aging characteristic factor.

11. The method of claim 10 further comprising:
simulating the circuit block based upon the set of aging device models and deriving a second set of electrical parameters;
calculating a second set of stress indexes based upon the second set of electrical parameters;
determining a second set of aging characteristic factors based upon a ratio of the second set of stress indexes versus the set of reference stress indexes; and
simulating the circuit using a second simulation tool using the second set of aging characteristic factors of each circuit block; and
determining a set of design corners of the circuit.

12. The method of claim 9, wherein the circuit includes at least one of a plurality of intellectual property cores, a plurality of semiconductor blocks, a plurality of semiconductor sub-blocks, and a plurality of semiconductor devices.

13. The method of claim 9, wherein the set of design corners comprise at least one of threshold voltage, delay time, or carrier mobility.

14. The method of claim 9, wherein the first simulation tool is one of an HSPICE, PSPICE or SPICE circuit simulation and the second simulation tool is a Hierarchical Simulator (HSIM) circuit simulation tool.

15. The method of claim 9, wherein the partitioning step is accomplished by dividing the circuit along a border between two intellectual property cores.

16. The method of claim 9, wherein the partitioning step is accomplished by dividing the circuit into a plurality of circuit blocks based upon operation conditions of each circuit block.

17. A computer readable medium containing an executable simulation program for assessing design corners of a system-on-chip design, the system-on-chip design comprising a plurality of elements, the elements including a plurality of intellectual property cores, semiconductor blocks and semiconductor devices, where the program performs the steps of:
partitioning a circuit into a plurality of circuit blocks;
simulating each circuit block of the plurality of circuit blocks using a first simulation tool and deriving a first set of electrical parameters for each circuit block;
calculating a first set of stress indexes based upon the first set of electrical parameters;
receiving a semiconductor characterization report having a set of reference stress indexes and corresponding aging characteristic factors;
determining a first set of aging characteristic factors based upon a ratio of the first set of stress indexes versus the set of reference stress indexes.
simulating the circuit using a second simulation tool using the first set of aging characteristic factors of each circuit block; and
determining a set of design corners of the circuit.

18. The computer readable medium of claim 17 further comprising:
providing a set of fresh device models;
providing a netlist of the circuit block; and
modifying the fresh device models and obtaining a set of aging device models based upon the aging characteristic factor.

19. The computer readable medium of claim 18 further comprising:
simulating the circuit block based upon the set of aging device models and deriving a second set of electrical parameters;
calculating a second set of stress indexes based upon the second set of electrical parameters;
determining a second set of aging characteristic factors based upon a ratio of the second set of stress indexes versus the set of reference stress indexes; and
simulating the circuit using a second simulation tool using the second set of aging characteristic factors of each circuit block; and
determining a set of design corners of the circuit.

20. The computer readable medium of claim 17, wherein the first simulation tool is one of an HSPICE, PSPICE and SPICE circuit simulation and the second simulation tool is HSIM circuit simulation.
